(19) United States
(12) Patent Application Publication
(10) Pub. No.: US 2008/0270384 A1
(43) Pub. Date: Oct. 30, 2008

(54) SYSTEM AND METHOD FOR INTELLIGENT ONTOLOGY BASED KNOWLEDGE SEARCH ENGINE

(76) Inventor: RAYMOND LEE SHU TAK, Kowloon (HK)

Correspondence Address: WEINER & BURT, P.C., 635 N US-23, POB 186, HARRISVILLE, MI, 48740, US

(21) Appl. No.: 11/942,408

(22) Filed: Nov. 19, 2007

(30) Foreign Application Priority Data
Apr. 28, 2007 (CN) 200710102961.3

(51) Int. Cl. G06F 17/30

(52) U.S. Cl. 707/5; 707/E17.071

(57) ABSTRACT

The present invention relates to a system and method for intelligent ontology based knowledge search engine (IATOPIA KnowledgeSeeker). Said IATOPIA KnowledgeSeeker, is an intelligent ontology-based system that is designed to help Web users to find, retrieve, and analyze any Web information such as news articles from the Internet and then present the content in a semantic web. We present the benefits of using ontologies to analyze the semantics of Chinese text, and also the advantages of using a semantic web to organize information semantically. IATOPIA KnowledgeSeeker also demonstrates the advantages of using ontologies to identify topics. We use a Chinese document corpus to evaluate IATOPIA KnowledgeSeeker and the testing result was compared to other approaches. It was found that the accuracy of identifying the topics of Chinese web articles is over 87%. It demonstrated a fast processing speed of less than one second per article. It also organizes content flexibly and understands knowledge accurately, unlike traditional text classification systems used in popular search engines today such as Google and Yahoo.

### FIELD OF THE INVENTION

The present invention relates to web search engine, more particularly, relates to a system and method for intelligent ontology based knowledge search engine.

### BACKGROUND OF THE INVENTION

Large amounts of information are now available on the World Wide Web (WWW). Numerous web sites publish many different kinds of information in different formats. Users may find it a difficult and time-consuming task to find information.

Currently, many web sites have search engines to help users to find information but these search engines do not always return search results that are relevant to users' requirements. This is because most popular search engines such as Google and Yahoo are keyword-based, and do not take account for the context and semantics of the text and consequently misinterpret it. Text semantics are major challenge for machine learning because they are produced through natural language, which is not machine-interpretable.

A second problem with traditional web-based information reporting systems is that they lack of intelligent features which can do tasks for users automatically and informatively. For example, most traditional reporting systems are pull-based, requiring user to make a specific request for information. An intelligent system would automatically seek out information that is relevant to users. An intelligent reporting and recommender system would also tell the user how that information is relevant.

### BRIEF SUMMARY OF THE INVENTION

The object of the present invention is, to provide a system and method for intelligent ontology based knowledge search engine.

Advantageously, a system for intelligent ontology based knowledge search engine, said system comprises:
ontology module, for analyzing and annotate Web articles;
intelligent features module, for processing the information from Internet using intelligent features process; and
semantic web module, for adding machine readable data into web content.

Advantageously, said ontology module comprises:
Article ontology, comprises article data and semantic data, annotated as an instance of the class Article to express its semantic content in a machine understandable format;
Topic ontology, defined to model the area of topic in hierarchical relations and is used to identify the topic of an article;
lexical ontology, for analyzing Chinese text articles and understanding semantics in Chinese natural language text in HowNet.

Advantageously, said ontology module comprises:
feature selection module, for processing of selecting appropriate sememes that can typically represent a topic class that is defined in the Topic ontology;
feature vectors Process module, for Mapping topic entry to sememe;
feature weighting module; using Features vector creation algorithm obtained the sememe's weighting and obtainedVectors for all topic classes obtained.

Advantageously, said intelligent features module comprise:
Info-Retrieval Module, for connecting to the internet to retrieve web pages to obtain useful articles as sources of information;
Info-Analysis Process Module, for seeking to analyze and understand the semantic content of articles collected from web sites;
Info-Annotation Process Module, for annotating the information content into a semantic ontology based format, said the ontology based format used is RDF;
Info-Recommendation Process Module, for providing articles that might be relevant or of interest to users, comprises providing personalized content and similar-content recommendation that recommends news articles with similar content to user.

Advantageously, said Info-Analysis Process Module comprise:
Textual Analysis Module, for text segmentation, and using some matching algorithm to match the longest word possible;
Sememe Extraction Module, for extracting a list of related sememes from a “word” in the article;
Entity Ontology Matching Module, for the sememe matching and mapping onto the abstract concept;
Sememe Weighting Module, for weighting Sememes according to its count in the text
Topic Identification Module, for finding the set of topics that the article is related to.

Advantageously, said system further comprises comprises:

IATo News, for providing a fully automatic, ontology-based, personalized RSS-based news reading platform.

Advantageously, said IATo News comprises:
Ontology concept tree, contains over 20000 Chinese concepts and knowledge, which provided to said IATo News to use;
5-D KnowledgeWheel, for providing a 5-dimensional knowledge seeking functionality, comprises People, Organization, Event, Thing, Place;
Multi-Level Article Analyzer, for providing links for user to further their search of related articles according to these news article categories;
Personalized IATo News process module, for providing an innovative and breakthrough article search and reading platform that allow users to personalize their IATo News reading and search platform in two perspectives, comprises Personalized News Categorization Scheme and Preferred News and Automatic Categorization Scheme.
   a method for intelligent ontology based knowledge search engine, comprises:

a. The IATOPIA KnowledgeSeeker Obtains web source in HTML, and then extracts semantic content from the HTML;

b. The IATOPIA KnowledgeSeeker further analyzes said semantic content by using ontologies knowledge to retrieve the text semantics which is then annotated in RDF, and presents content to users through the web interface.

Advantageously, said step b comprises:

b1. The step of Info-Retrieval Process;

b2. The step of Info-Analysis Process;

b3. The step of Info-Annotation Process;

b4. The step of Info-Recommendation Process.

The present invention provides system and method for intelligent ontology based knowledge search engine, Said IATOPIA KnowledgeSeeker deals with these issues by using various machine intelligence techniques to retrieve, process, analyze and recommend web-based articles. In particular, it focuses on Chinese web news article as the information domain. By apply Chinese ontology, IATOPIA KnowledgeSeeker contains an ontology tree for over 20000 Chinese concepts and knowledge—the so-called “IATOLOGY-20000”, to tackle with the complex semantic and knowledge seeking of Chinese articles and information over the Internet.

### BRIEF DESCRIPTION OF THE DRAWINGS

FIG. 1 is the structure diagram of a system for intelligent ontology based knowledge search engine, in accordance with the present invention.

FIG. 2 is the schematic diagram of ontology representation of article ontology class, in accordance with the present invention.

FIG. 3 is the schematic diagram of semantic relationship of Chinese words in HowNet, in accordance with the present invention.

FIG. 4 is the schematic diagram of mapping topic entry to sememe, in accordance with the present invention.

FIG. 5 is the schematic diagram of data flow between four sub-system, in accordance with the present invention.

FIG. 6 is the main flow chart of main process flow of info-analysis, in accordance with the present invention.

FIG. 7 is the schematic diagram of linkage between article text and lexicon ontology, in accordance with the present invention.

FIG. 8 is the schematic diagram of RDF annotations for article, in accordance with the present invention.

FIG. 9 is the schematic diagram of the IATo News, in accordance with the present invention.

FIG. 10 is the schematic diagram of the first two layers of IATOLOGY-20000, in accordance with the present invention.

FIG. 11 is the schematic diagram of 5-D knowledgeWheel, in accordance with the present invention.

FIG. 12 is the schematic diagram of IATo News with 5-D knowledgeWheel, in accordance with the present invention.

FIG. 13 is the schematic diagram of Multi-Level Article Analyzer, in accordance with the present invention.

FIG. 14 is the schematic diagram of IATo News with Multi-Level Article Analyzer, in accordance with the present invention.

FIG. 15 is the schematic diagram of personalized recommendation of news in IATo News, in accordance with the present invention.

### DETAILED DESCRIPTION OF THE INVENTION

1. The present Invention Technology

The present invention (IATOPIA KnowledgeSeeker) carries out information seeking tasks using ontology approach. This section describes the architectural design of IATOPIA KnowledgeSeeker, the ontology components being defined, detailed implementation design of different intelligent features, and the semantic web interface. IATOPIA KnowledgeSeeker is divided into three sub-modules: an ontology module, an intelligent features module, and a semantic web module.

### 1.1. System Architecture

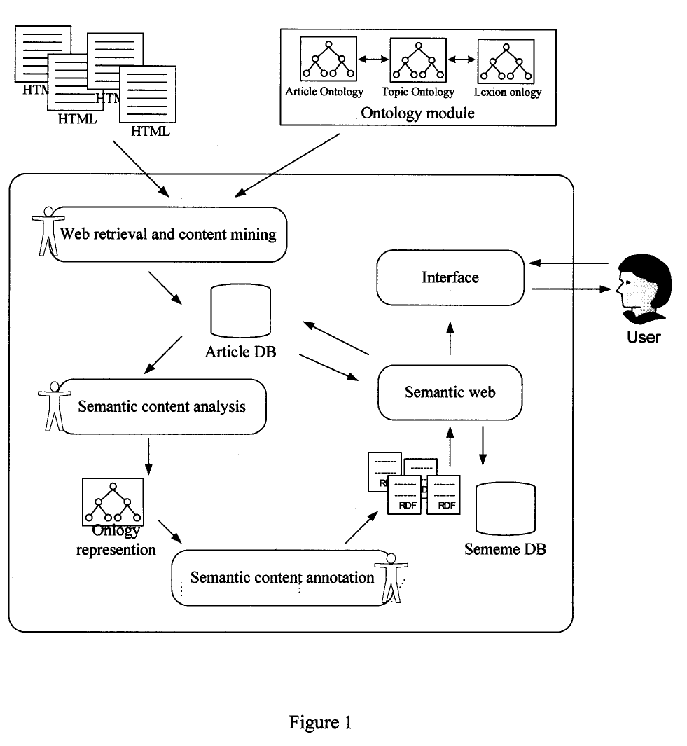

The system architecture of IATOPIA KnowledgeSeeker is shown in FIG. 1. The system first obtains web source in HTML, and then extracts content from the HTML. After that, content is further analyzed by using ontologies knowledge to retrieve the text semantics, which is then annotated in RDF, an ontology data format for knowledge storage. A semantic web is built upon on these annotation data together with the article data and presents content to users through the web interface. Details of the ontology that was used will be described in the following sub-sections.

### 1.2. Ontology Components Module for Knowledge Representation

There are three ontologies defined for the system to analyze and annotate Web articles (e.g. news articles). They are:
Article-ontology;
Topic-ontology;
Lexicon-ontology.

### 1.21. Article Ontology

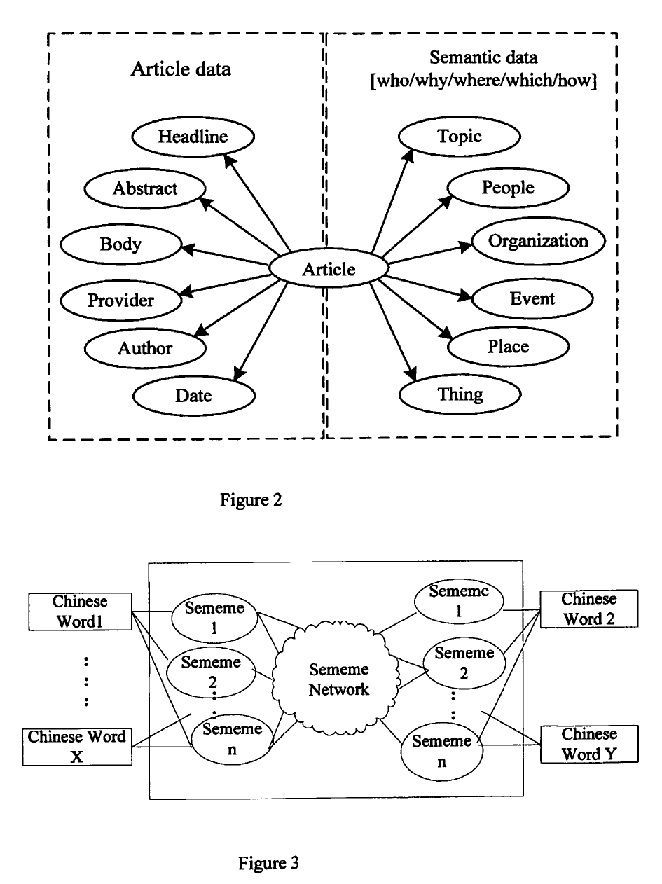

This ontology class is used in the article annotation process. Each article is annotated as an instance of the class Article to express its semantic content in a machine understandable format. FIG. 2 shows the ontology representation of the Article ontology class. The ontology properties are divided into two types: article data and semantic data. The article data represents the basic textual content about the article such as headline, abstract, and body. While the semantic data represents the semantic content and knowledge contained in the article text, known as semantic entities. We defined six semantic entities that are able to cover all semantic content in a text. They are topic, people, organization, event, place, and thing.

semantic data represents the semantic content and knowledge contained in the article text, known as semantic entities. We defined six semantic entities that are able to cover all semantic content in a text. They are topic, people, organization, event, place, and thing.

### 1.22. Topic Ontology

The Topic ontology is defined to model the area of topic (i.e. subject or theme) in hierarchical relations and is used to identify the topic of an article. The instances of a topic class are a set of controlled vocabularies for ease of machines processing, sharing, and exchange. The class was defined in hierarchical semantic relations. It is likely to be a topic-taxonomy but defined in detail, comprehensive and maintained with semantic relations.

### 1.23. Lexical Ontology

The lexical ontology is created and derived from HowNet, a Chinese-English bilingual word dictionary. It models concepts and relations of Chinese terms and it also defines properties and attributes. IATOPIA KnowledgeSeeker uses part of its structure to analyze Chinese text articles and to understand semantics in Chinese natural language text. The main component in HowNet for defining the Lexical ontology is the sememe definition. The sememe is used to model the concept of Chinese terms by describing their meaning physically, mentally, theoretically, or abstractly. FIG. 3 shows the sememe definition that models the semantic relationship of Chinese words.

1.24. Identifying topics using the ontological features selection process

Feature selection module is the process of selecting appropriate sememes that can typically represent a topic class that is defined in the Topic ontology. A very small number of sememe (normally two to ten) is selected for every topic class. Every sememe representing a topic class is assigned a weight, which is used to depict how important the sememe is in representing the topic entry.

### 1.25. Process of Creating Feature Vectors Module

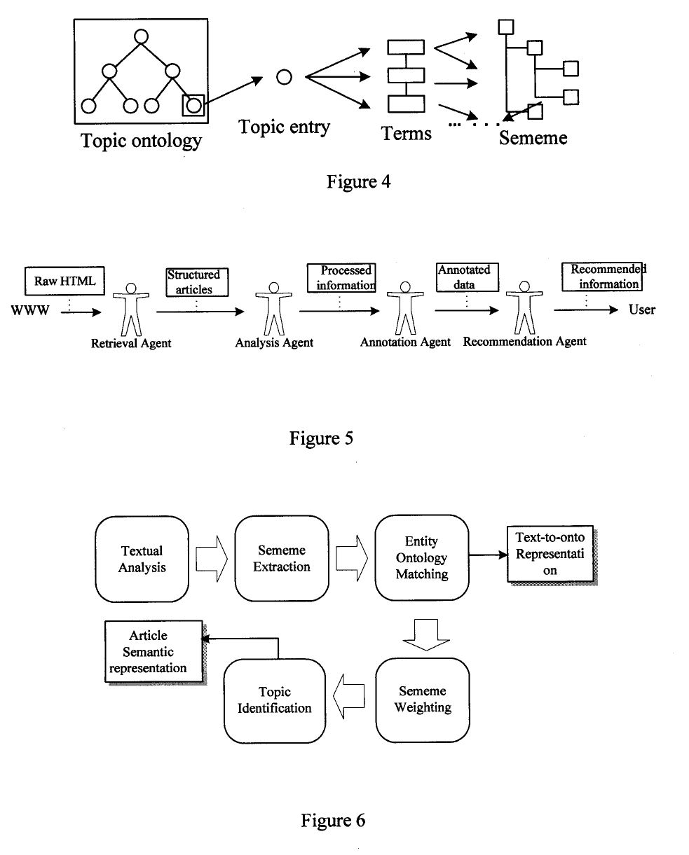

Every topic class in a topic-ontology is made up of a set of terms or phrases. A class is further linked with a small number of sememes to form the feature vectors. Since sememes are enhanced in the sememe network, both a topic and an article analysis can rely on the sememe network instead of explicit term matching. Therefore, a small feature vector sufficiently represents the meaning of a topic class. FIG. 4 shows the co-relation of a topic-ontology and sememes in the lexical ontology.

### 1.26. Feature Weighting Module

The sememe entries in the feature vector are further weighted by the importance of the feature to the topic node. This is done in a similar way to the method used in the weighting algorithm in an information retrieval system. First, a corpus consists of documents which are able to cover all the sememes obtained as the training examples. Then, terms in the documents are extracted and linked to sememes by a sememe network in HowNet. After that, the sememe frequency (fⱼ) is treated as the term frequency (tfⱼ), and the document frequency (dfⱼ) can also be obtained. Finally, the weighting is defined as:

$${w}_{i , j} = \frac{{f}_{i , j}}{{\sum }_{j} {f}_{i , j}} \times {log}_{2} ( \frac{N}{{df}_{j}} ) \qquad ( 1 )$$

Features vector creation algorithm:
Assume the set of topic classes is {c₁,c₂,c₃ . . . c ₙ}
For i from 1 to n
Extract list of sememe for cᵢ: (s₁,f₁),(s₂,f₂) . . . (sₖ,fₖ)
For j from 1 to k
Normalize nfⱼ=fⱼ/sum(f₁ to fₖ)
Weight wfⱼ=fⱼ×weight(sⱼ)

Next

Return features vector for cᵢ: vᵢ=<(s₁,wf₁),(s₂,wf₂) . . . (sₖ,wfₖ)>

Vectors for all topic classes obtained: {ν₁,ν₂,ν₃ . . . νₙ}

### 1.3. Intelligent Components Module

Four different sub-processes are defined to process different tasks. FIG. 5 shows the information flow between different sub-process.

### 1.31. Info-Retrieval Process Module

An Info-Retrieval process is a process that gathers information from the Internet. It connects to the internet to retrieve web pages to obtain useful articles as sources of information. Articles are mainly from popular international news publication web sites such as the BBC, CNN, etc. This is one source used in this project.

### 1.32. Info-Analysis Process Module

An Info-Analysis sub-system seeks to analyze and understand the semantic content of articles collected from web sites. Since all articles are written in natural language text in Chinese, it is necessary to use an effective and accurate text analysis method. An ontology approach is also used with a developed algorithm to process topic identification processes. FIG. 6 shows the main process flow for text analysis applied in info-analysis sub-system.

### Textual Analysis Module

The first task in textual analysis is text segmentation. The text segmenter adopted in this analysis process works with a version of the maximal matching algorithm. The algorithm tries to match the longest word possible when looking for a word token. This is a simple and effective algorithm for tokenizing.

### Sememe Extraction Module

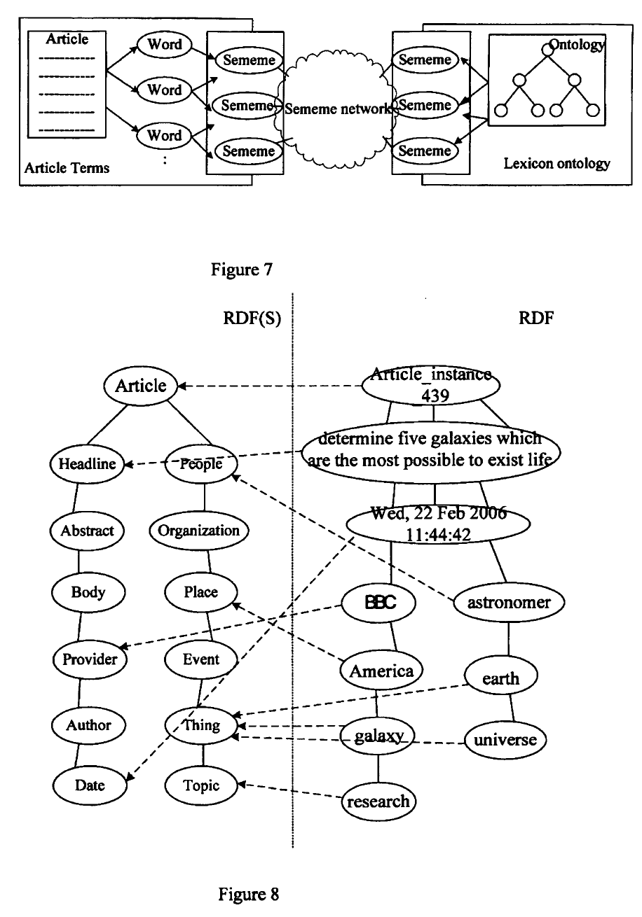

The purpose of sememe extraction is to extract a list of related sememes from a “word” in the article. The sememe is extracted with the used of a lexical ontology. Every single word can be mapped into one or more sememes based on the HowNet definition. After the sememe extraction process, an article text is conceptually and semantically linked to the HowNet lexicon. This linkage is created like a semantic bridge between the article text and the HowNet lexical ontology, while the semantic bridge is defined by a set of related sememes, as shown in FIG. 7.

### Entity Ontology Matching Module

The sememe is then matched and mapped onto the abstract concept. The abstract concepts are defined in the entity ontology. Five different types of abstract concepts are used and matched. They are people, organizations, places, events, and things. The frequency of an abstract concept is counted if it exceeds a predefined threshold. This step further processes the sememe so as to find its related concept.

### Sememe Weighting Module

Sememes are weighted according to its count in the text. It comprises with five vectors and each of them contains a list of sememe entries with its corresponding weightings. This semantic matching can be used to form an instance of the article's semantic representation. The article's semantic representation is the instance of Article ontology that was defined in the ontology module.

### Topic Identification

The main process of topic identification is to find the set of topics that the article is related to. This can be treated as the categorization or classification of articles but there are multiple topics being identified rather than only one category or class to be classified as in a normal categorization or classification process. The terms of the topic being identified are limited to the topic class constructed in the Topic ontology. The process of identifying a related topic includes calculating and giving a score (or weight) to every topic node in the Topic ontology tree.

The scoring process is the main part of topic identification. First, the sememe is extracted from the semantic representation of the article. Second, the sememe is matched into every feature vector that corresponds to every topic node in the Topic ontology. An article's sememe was already weighted in the previous step but the feature vectors are weighted in the features selection step, so there are two weighting score in both representations for use in the calculation.

We assume that the set of ontology topic nodes is {c₁, c₂, c₁ . . . cₙ}, and pay no regard to the relationship of hierarchical levels. Then we can obtain the features vector {v₁, v₂, v₁ . . . vₙ} for every class c₁ with v₁=<(s₁, wf₁), (s₂, wf₂) . . . (sₖ, wfₖ)>while wfi,j is the weighted score of the sememe sj in vector vi. Then, the article's sememe list is defined by vₘ=<(s₁, wf₁), (s₂, wf₂) . . . (sₖ, wfₖ) for article m, and wfm,n is the weighted score of sememe sn in vector vm. The score of class ci for article am is defined as:

Score(aₘ,cᵢ)=Σwf_{i,j}.wf_{m,n} for every j=n (2)

It is possible to refine the hierarchical score of every class. This is to pass a parent's topic score to a child topic, by simple addition.

If Score(am, ci)>0, then

Score(am,ci)=Σwfi,j.wfm, n+Score(am, parent(cx)) (3)

1.33. Info-Annotation Process module

The Info-Annotation Process module annotates the information content into a semantic ontology based format. The ontology based format used is RDF, which is the schema defined and constructed in the ontology module. RDF annotation also enables semantic querying of the semantic web. Semantic querying is constructed to query the information stored in RDF. This enhances the semantic search by querying based on the classes, attributes and properties defined in RDFS or from imported ontology stored in RDF(S). FIG. 8 shows the RDF storage and annotation data.

### 1.34. Info-Recommendation Process Module

IATOPIA KnowledgeSeeker adopts an ontology based recommendation approach to develop the recommendation process. Recommender system aims to provide articles that might be relevant or of interest to users. There are two different types of recommendation process. The first type is personalized content based recommendation that makes recommendations based on user preferences. It provides a personalized list of articles to users when users are online. The second type is similar-content recommendation that recommends news articles with similar content. It immediately recommends related articles to users based on the current article that the user is browsing.

### Personalized Content Based Recommendation

This recommendation process is able to record the reading behavior or habit based on the user's reading history and previous browsing action. It keeps an ontology based user profile for the target users and then tries to find out what related subject and news information content is of interest to them. It then analyzes the similarity of all the news content with the user's reading interest so that it can recommend and report only news of potential interest to the target user.

The recommendation process maintains the ontology content based profile for the user, and a utility function u(c, s) is defined to find the score of content s to user c:

uₚ(c, s)=score (OntologyContentBasedProfile(c), Content(s)) (4)

By using the profile vector, the system is then able to calculate the ontological similarity between the profile of user c and content s:

uₚ(c, s)=similarity(\vec{w_{c}},\vec{wₛ})=Σwf_{c,j}. wf_{s,n} for every j=n (5)

### Similar Content Recommendation

The second type of recommendation process is similar to the content based recommendation. It is used when the user is browsing a particular news article. At the same time the system is able to find news articles with similar content to the current article by measuring the similarity of semantic entities (i.e. subjects, people, places, events).

The goal of the utility function for calculating a score is to identify a degree of similarity of content m and content n, defined as U_{c}(m,n)=similarity (wₘ, wₙ). Particular semantic entities may require different weights. For example, the subject may be the most important issue in retrieving semantically similar content. However, it may vary based on different user interpretations and may also vary from different article contents.

### 1.4. Semantic Web Module

A semantic web module refers to the user interface design and layout for representing information in a semantic manner. It is the main interface for users to view and browse all the information obtained from the system module. The server collects responses from the system process comprising the result and presents the information in a web page.

A web module is developed by following the data layer of the W3C semantic web architecture. The purpose of building the semantic web is to add machine readable data into web content in order to make it machine understandable. In addition, content in a semantic web is largely supported by ontology vocabularies that are required in the data layer. These also provide the ability to organize the information with semantic relations and it is the main reason for developing the semantic web module.

### 2. The Application—IATo News

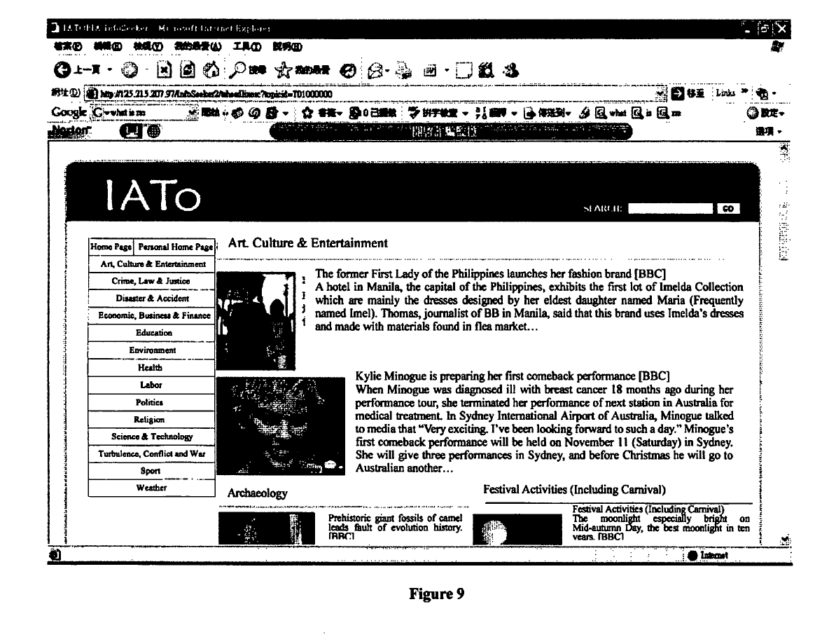

Based on the IATOPIA KnowledgeSeeker main modules and technologies described in section 2, the first, and one of the most important intelligent ontology-based RSS News Reader—the “IATO News” is developed to provide a fully automatic, ontology-based, personalized RSS-based news reading platform. FIG. 9 shows the sample screen shot of IATo News.

Core functions and features of IATo News include:

1) Ontology concept tree (IATOLOGY-20000);

2) 5-D KnowledgeWheel;

3) Multi-level Article Analyzer;

4) Personalized IATo News;

### 2.1. IATOLOGY-20000

IATOLOGY-20000 is a comprehensive Chinese ontology tree which contains over 20000 Chinese concepts and knowledge. The first layer (core) of IATOLOGY-20000 contains 17 most popular Topics of Interests (ToIs) which is adopted as the “basic category” in the IATo News. In fact, such categorization scheme can be changed according to the user preference, which will be described in the “Personalized IATo News” scheme in the following sections.

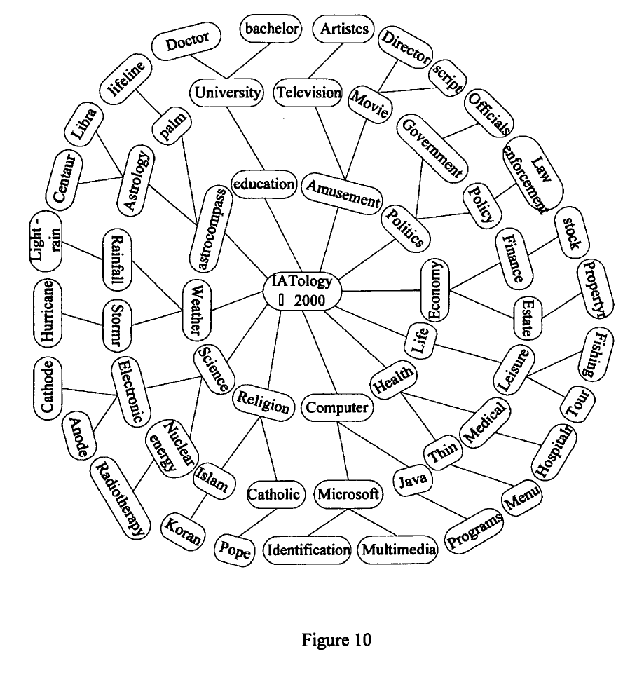

FIG. 10 depicts the first two layers of IATOLOGY-20000 which is used in IATo News for the main categorization of news articles.

### 2.2. 5-D KnowledgeWheel

The 5-D KnowledgeWheel provides a 5-dimensional knowledge seeking functionality by adopting the multi-ontology categorization techniques described in section 2 of this patent document.

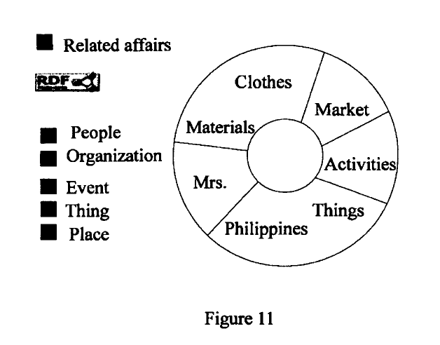

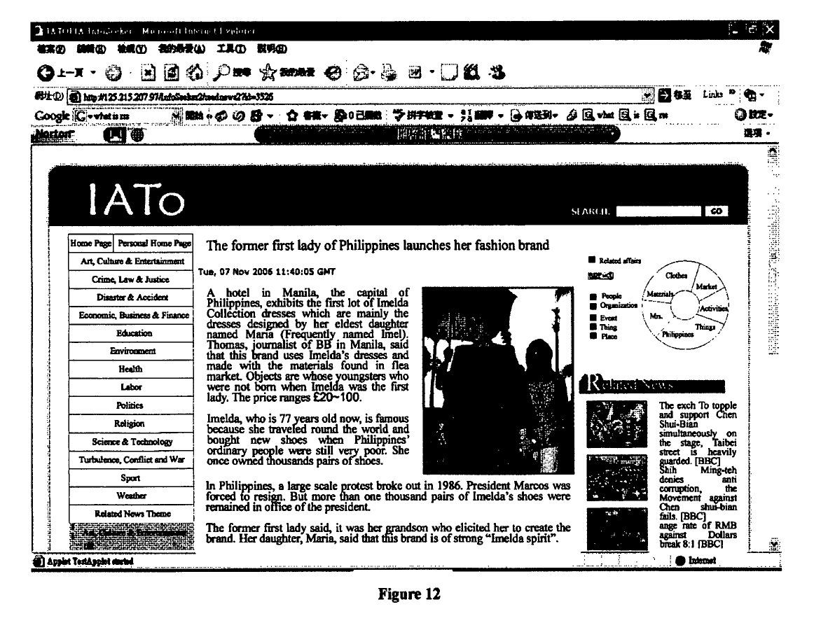

In IATo News, the 5-D KnowledgeWheel include: People, Organization, Event, Thing, Place, as shown in FIG. 11, FIG. 12. In other words, every single news article is categorized according to these five different perspectives. The users can further their search of related articles tracing any of these five different directions, instead of wide guessing of related keywords to further their search.

### 2.3. Multi-Level Article Analyzer

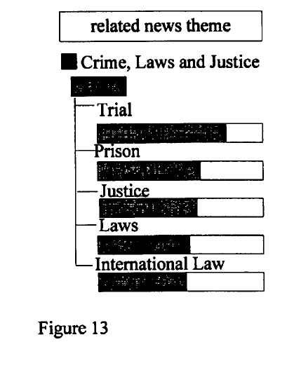

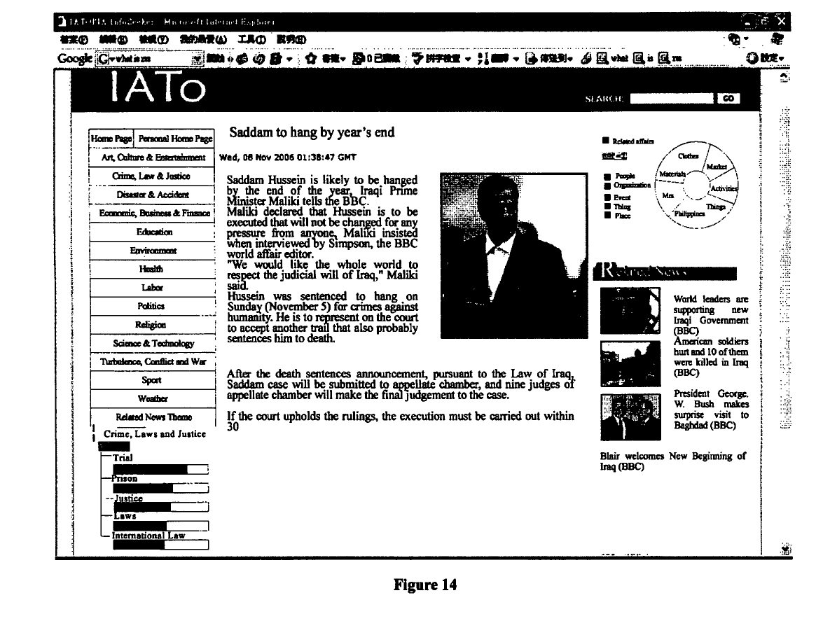

With the incorporation of IATOLOGY-20000 and intelligent knowledge analyzing technique, IATo News provides an in-depth analysis of news articles—the “Multi-Level Article Analyzer”. FIG. 13 depicts a typical analysis of an international news about the trial of Saddam Hussein, which belongs to main ontology: “Crime, Laws and Justice”; with the sub-category of: Trial (90%), Prison (70%), Justice (69%), Laws (65%) and International Law (61%). More importantly, this analysis tool provides links for user to further their search of related articles according to these sub-categories. FIG. 14 provide the screenshot of the original news article, together with the Multi-Level Article Analyzer and the 5-D KnowledgeWheel.

### 2.4. Personalized IATo News Module

With the adoption of ONTOLOGY-20000 and intelligent article categorization and analysis techniques, IATo News provides an innovative and breakthrough article search and reading platform that allow users to personalize their IATo News reading and search platform in two perspectives.
a. Personalized News Categorization Scheme (PNCS);
b. Preferred News and Automatic Categorization Scheme (PNACS).

In addition to the “standard” news categorization scheme (according the IATOLOGY-20000 ontology), PNCS allows user to define their own categorization scheme by adding any new topics of interests (ToIs). More importantly, all the news feed categorization and analysis will follow these Tols. Besides, IATo News can add new Tols automatically onto the “Personalized IATo News Homepage” accord to the reading habit for a particular Tol of news articles.

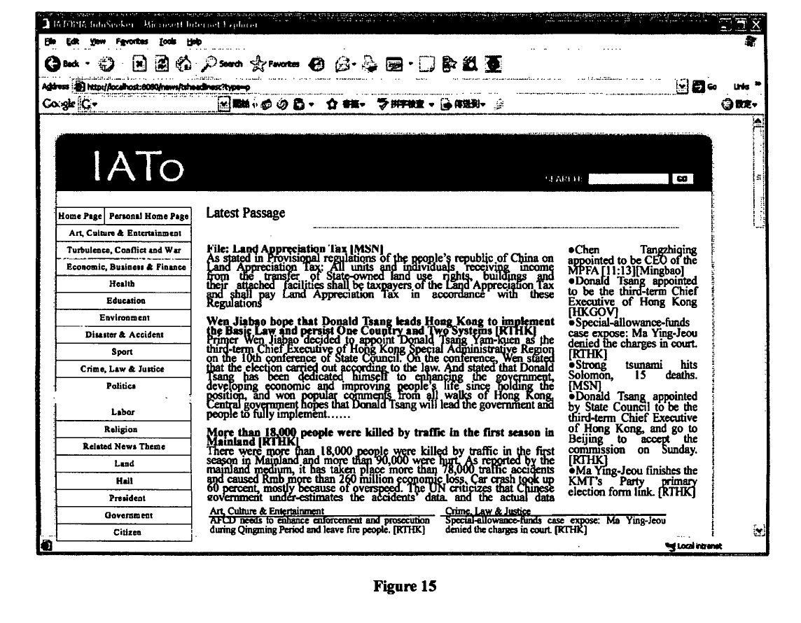

With the adoption of fuzzy logic, PNACS allows user to rank the “Degree of Readiness” for his/her preferred news articles (and their Tols). IATo News will then search and provide all the related preferred news in priority. FIG. 15 depicts the screenshot of Personalized IATo News.

### 3. System Performance

### 3.1. Topic Identification Precision.

The topic identification process is evaluated by using a Chinese text corpus. The corpus is classified into five topics and thus the corresponding five level-1 topic classes in the Topic ontology are selected for this evaluation. The average topic identification precision rate is about 87%. This is highly acceptable rate for a text classification system. The goal of efficiency measurement is to measure the speed for the topic identification process. There are many algorithm exists in text classification and categorization, such as artificial neural networks (ANNs) and Rocchio-TFIDF. Previous results from other researchers show that a TFIDF algorithm performs faster than an ANN algorithm and it is quite a speedy algorithm for text classification compared to many other algorithms. Therefore, this test focuses on comparing the speed of identifying a topic of IATOPIA KnowledgeSeeker and a traditional Rocchio-TFIDF algorithm.

### 3.2. Topic Identification Processing Speed

The test is processed by three different document sets selected in the testing document corpus. Each of them contains 3000 articles that are written in Chinese text with similar numbers of characters. The results (see Table 1) show that IATOPIA KnowledgeSeeker is very fast compared to the TFIDF approach. It takes on average less than one second to process a document. Moreover, multiple topics are already identified in the time spent.

TABLE I
Time taken for identifying topic of three document sets:

| | | IATOPIA |
|---|---|---|
| | TFIDF | KnowledgeSeeker |
| Document Set 1 | 1561 seconds | 202 seconds |
| Document Set 2 | 1692 seconds | 232 seconds |
| Document Set 3 | 1564 seconds | 206 seconds |
| Average | 1606 seconds | 213 seconds |

3.3. Comparison to other Algorithms

Besides the time and speed factors discussed above, there are also other different performance achievements for the IATOPIA KnowledgeSeeker. (See Table II)

TABLE II
Comparison between different algorithms:

| | | | IATOPIA |
|---|---|---|---|
| | ANN | TFIDF | KnowledgeSeeker |
| Classification speed | Low | Medium | Fast |
| Corpus training | Required | Required | Not required |
| Corpus training time | Medium | Medium | None |
| Classification flexibility | Low | Low | High |
| Semantic understanding | Medium | Medium | High |
| Classification accuracy | Low | High | High |

### 4. Conclusion and Potential Applications

IATOPIA KnowledgeSeeker effectively carries out knowledge seeking task for users. By using different ontologies, the system can understand the context of an article more accurately and identify the topic that each article is related to. Semantic annotation provides the advantages of fast retrieval of semantically similar articles from a large text corpus, which is used to create the recommendation content. These semantic relations based on the semantic similarity are created autonomously in a way that many existing system are unable to do. Using personalized profile to keep track of user interests means that users are not required to be aware of what they are interested in. This concern can be delegated to the system, which can deal with this autonomously. This is efficient for users because they do not need to be aware of what sorts of topics they have been reading recently. The topic area of interest can be automatically discovered, so that users can get all of the recommended articles based on their personalized profile.

From the application point of view, this patent document elaborates one of the most important applications of IATOPIA KnowledgeSeeker technology, the “IATo News”, an innovative intelligent ontology-based RSS news seeking and reading platform with Mutli-Level News Analyzer, 5-D KnowledgeWheel, IATOLOGY-20000 and AI-based personalization technologies.

In fact, IATOPIA KnowledgeSeeker can be adopted in many other areas such as (but not limited to):

1) Ontology-based Content Management System (CMS) (IATO CMS) and KnowledgeSeeker such as (but not limited to):
Ontology-based health System (IATo Health);
Ontology-based medical System (IATo Medical);
Ontology-based finance System (IATo Finance);
Ontology-based law system (IATo Law);
Ontology-based travel system (IATo Travel);
Ontology-based music system (IATo Music);
Ontology-based science system (IATo Science);
Ontology-based arts system (IATo Arts);
Ontology-based living system (IATo Living);
Ontology-based beauty system (IATo Beauty);
Ontology-based sprots system (IATo Sports);
Ontology-based JobSeeker system (IATO JobSeeker);
Ontology-based movie system (IATo Movie)
Ontology-based weather system (IATo Weather)
Ontology-based shopping system (IATo Shopping)
Ontology-based food system (IATo Food)

2) Ontology-based Broadcasting System (IATo Broadcaster)

3) Ontology-based e-Magazine Reader (IATo Magazine)

1. A system for an intelligent ontology based knowledge search engine, wherein said system comprises:
an ontology module for analyzing and annotating Web articles;
an intelligent features module for processing information from the Internet using an intelligent features process; and
a semantic web module for adding machine readable data into web content.

2. A system according to claim 1, wherein said ontology module comprises:
article ontology including article data and semantic data, annotated to express in a machine understandable format semantic content of a Web article;
topic ontology defined to model the area of topic in hierarchical relations and to identify the topic of said article; and
lexical ontology for analyzing Chinese text articles and understanding semantics in Chinese natural language text in HowNet.

3. A system according to claim 2, wherein said ontology module further comprises:
a feature selection module for processing of selecting appropriate sememes that can typically represent a topic class that is defined in said topic ontology;
a feature vectors process module for mapping topic entry to sememe;
a feature weighting module using a features vector creation algorithm incorporating sememe weighting and vectors for all topic classes obtained.

4. A system according to claim 1, wherein said intelligent features module comprises:
an Info-Retrieval Module for connecting to the internet to retrieve web pages to obtain useful articles as sources of information;
an Info-Analysis Process Module for analyzing and understanding the semantic content of articles collected from web sites;
an Info-Annotation Process Module for annotating the information content into a semantic ontology based format such as RDF;
an Info-Recommendation Process Module for providing articles that might be relevant or of interest to users based on personalized content and similar-content recommendations which recommends news articles with similar content to users.

5. A system to claim 4, wherein said Info-Analysis Process Module comprises:
a Textual Analysis Module for text segmentation and using a matching algorithm to match the longest word possible;
a Sememe Extraction Module for extracting a list of related sememes from a “word” in a Web article;
an Entity Ontology Matching Module for sememe matching and mapping onto an abstract concept;
a Sememe Weighting Module for weighting sememes according to its count in the text of said Web article; and
a Topic Identification Module for finding a set of topics to which said article is related.

6. A system according to claim 1, including:
IATo News for providing a fully automatic, ontology-based, personalized RSS-based news reading platform.

7. A system according to claim 2, including:
IATo News for providing a fully automatic, ontology-based, personalized RSS-based news reading platform.

8. A system according to claim 3, including:
IATo News for providing a fully automatic, ontology-based, personalized RSS-based news reading platform.

9. A system according to claim 4, including:
IATo News for providing a fully automatic, ontology-based, personalized RSS-based news reading platform.

10. A system according to claim 5, including:
IATo News for providing a fully automatic, ontology-based, personalized RSS-based news reading platform.

11. A system according to claim 6, wherein said IATo News comprises:
an ontology concept tree, containing over 20000 Chinese concepts and knowledge, which is provided to said IATo News to use;
a 5-D KnowledgeWheel for providing a 5-dimensional knowledge seeking functionality with respect to People, Organization, Event, Thing, and Place;
a Multi-Level Article Analyzer for providing links for users to further their search of related articles according to news article sub-categories; and
a Personalized IATo News process module for providing an article search and reading platform that allow users to personalize their IATo News reading and search platform in two perspectives comprising a Personalized News Categorization Scheme and a Preferred News and Automatic Categorization Scheme.

12. A system according to claim 7, wherein said IATo News comprises:
an ontology concept tree, containing over 20000 Chinese concepts and knowledge, which is provided to said IATo News to use;
a 5-D KnowledgeWheel for providing a 5-dimensional knowledge seeking functionality with respect to People, Organization, Event, Thing, and Place;
a Multi-Level Article Analyzer for providing links for users to further their search of related articles according to news article sub-categories; and
a Personalized IATo News process module for providing an article search and reading platform that allow users to personalize their IATo News reading and search platform in two perspectives comprising a Personalized News Categorization Scheme and a Preferred News and Automatic Categorization Scheme.

13. A system according to claim 8, wherein said IATo News comprises:
an ontology concept tree, containing over 20000 Chinese concepts and knowledge, which is provided to said IATo News to use;
a 5-D KnowledgeWheel for providing a 5-dimensional knowledge seeking functionality with respect to People, Organization, Event, Thing, and Place;
a Multi-Level Article Analyzer for providing links for users to further their search of related articles according to news article sub-categories; and
a Personalized IATo News process module for providing an article search and reading platform that allow users to personalize their IATo News reading and search platform in two perspectives comprising a Personalized News Categorization Scheme and a Preferred News and Automatic Categorization Scheme.

14. A system according to claim 9, wherein said IATo News comprises:
an ontology concept tree, containing over 20000 Chinese concepts and knowledge, which is provided to said IATo News to use;
a 5-D KnowledgeWheel for providing a 5-dimensional knowledge seeking functionality with respect to People, Organization, Event, Thing, and Place;
a Multi-Level Article Analyzer for providing links for users to further their search of related articles according to news article sub-categories; and
a Personalized IATo News process module for providing an article search and reading platform that allow users to personalize their IATo News reading and search platform in two perspectives comprising a Personalized News Categorization Scheme and a Preferred News and Automatic Categorization Scheme.

15. A system according to claim 10, wherein said IATo News comprises:
an ontology concept tree, containing over 20000 Chinese concepts and knowledge, which is provided to said IATo News to use;
a 5-D KnowledgeWheel for providing a 5-dimensional knowledge seeking functionality with respect to People, Organization, Event, Thing, and Place;
a Multi-Level Article Analyzer for providing links for users to further their search of related articles according to news article sub-categories; and
a Personalized IATo News process module for providing an article search and reading platform that allow users to personalize their IATo News reading and search platform in two perspectives comprising a Personalized News Categorization Scheme and a Preferred News and Automatic Categorization Scheme.

16. A method for an intelligent ontology based knowledge search engine, comprising the steps of:
a) using an IATOPIA KnowledgeSeeker to obtain web source in HTML, and then to extract semantic content from said HTML; and
b) using said IATOPIA KnowledgeSeeker to analyze said semantic content by using ontologies knowledge to retrieve text semantics which is then annotated in RDF, and presented to users through a web interface.

17. A method according to claim 16, wherein said step b) comprises:
a sub-step of Info-Retrieval Process;
a sub-step of Info-Analysis Process;
a sub-step of Info-Annotation Process; and
a sub-step of Info-Recommendation Process.
